(19) United States
(12) Patent Application Publication
(10) Pub. No.: US 2004/0010472 A1
(43) Pub. Date: Jan. 15, 2004

(54) System and method for verifying information

(76) Inventors: Robert T. Hilby, Ft. Lauderdale, FL (US); Howard B. Markowitz, North Miami Beach, FL (US)

Correspondence Address: Supervisor, Patent Prosecution Services, PIPER RUDNICK LLP, 1200 Nineteenth Street, N.W., Washington, DC, 20036-2412, US

(21) Appl. No.: 10/193,106

(22) Filed: Jul. 12, 2002

(51) Int. Cl. G06F 17/60

(52) U.S. Cl. 705/67

(57) ABSTRACT

A system and method for verifying information, such as user identity information and location, as well as authorization information, such as approval for charges for goods or services, which are usable for such functions as providing remote purchasing by and billing of users. Two elements of information are used to establish verification and authorization: 1) establishment of identity of the user; and 2) establishment of location information for the user that is linkable to that user. In one variation, both soft and hard connection to the user (e.g., Internet based and wired telephone based, connection respectively) are used to verify the user's identity and location. The approach of the present invention also meets the governmental compliance criteria.

### BACKGROUND OF THE INVENTION

1. Field of the Invention

The present invention-relates generally to verifying information, and more specifically to verifying the identity of a remote user, such as to verify identity information for charges incurred via a network, such as the Internet.

2. Background of the Technology

Internet technologies have had a tremendous impact and have provided a profitable new venue in which to market entertainment and information, as well as other goods and services, in the past few years. However, along with that growth has come the continued challenge of regulatory compliance for identity and other verification required by various Government Agencies.

One concern is the identity of the user. A challenge for Web sites is to provide a means of authenticating age. One way to solve this problem is by requiring a consumer to present a credit card. However, in some cases, a consumer does not wish to use or does not have a Credit Card to present to a Web site to authenticate age.

However, the general lack of independent verifiability of the methods of the prior art have led to problems, resulting, for example, from fraudulent provision of information. In addition, changing regulatory requirements are bringing into question these existing methods. There thus remains an unmet need to provide independent assurance and verification of a user's identity and proper authorization for obtaining network-based goods and services.

These difficulties are exacerbated by limitations on use of networks, including the Internet, such that the physical location of a user and the user's identity are often difficult to establish. For example, each Internet user has an Internet Protocol (IP) address, and that IP address is usually associated with some fixed geographical location. However, because IP addresses are allocated by different administrative entity, knowing the geographical location of an administrative entity does not automatically provide information about the IP address locations.

In addition, under some circumstances, it is virtually impossible to determine the precise physical location of an Internet user, such as a user connecting to the Internet through a dial-up modem. In order to better determine the identity of a person attempting to access a host computer system, many systems require the person to provide information confirming identity. The user authentication processes of the prior art assess the validity of an assertion about the identity of a user. Examples of identity information typically used in the prior art include information the user knows, use of an object the user possesses, and personal characteristic information for the user.

Examples of information the user knows include passwords, PINs, and cryptographic methods for authentication (including one-time passwords and challenge-response protocols). This information may include, for example, a code key, or a PIN or password that provides access to a code key.

Examples of objects the user possesses that can be used for identity verification include physical keys, smart cards, cryptographic devices, one time password generators, and dial-back mechanisms. These objects are often used in conjunction with PINs or passwords to control activation of the objects.

Examples of a user's personal characteristics usable for these purposes include biometric characteristics, such finger and thumb prints, hand geometry, voice prints, retinal scans, keystroke patterns, and handwritten signatures.

There have been several attempts to meet existing needs relating to this technology, including the following. It is know in the art to provide billing via a 900 number call, which is known as Transaction Code Billing. With this technology, the caller may be billed to a home telephone bill via a 900 call and receive during the call an access PIN that allows access to participating Web sites.

These 900 call services have also been offered so as to allow for simple Web Pin Access (Transaction Code). Via governmental uses of these services, users are able, for example, to track, acquire, and submit requests for Passports, Visas, and other Government Issued Identity Verification Services via the 900 Call Process.

In another example of the prior art, Internet Billing Company (iBill) of Fort Lauderdale, Fla., provides secure transaction services that enable Web merchants to accept and process real-time payments for good and services purchased over the Internet. iBill integrates online payment processing, fraud control, affiliate management, and financial reporting and tracking.

However, there are many unresolved problems with identification methods of the prior art. For example, passwords, and PINs can be compromised by interception (e.g., by sniffer programs on networks), and brute force searches. Physical keys and other physical objects can be stolen, and telephone lines can be hijacked. Biometric characteristics can lead to false positives (permitting unauthorized users) and false negatives (denying legitimate access).

There is thus a current need to provide a system and method that provides a greater degree of security against unauthorized access. There is an additional need provide such systems and methods that comply with various rules and regulations. Furthermore, an unmet need exists for systems and methods that can be used by numerous companies, such as Local Exchange Carriers (LECs), to verify and confirm the identity of individuals incurring charges over networks, such as the Internet.

### SUMMARY OF THE INVENTION

The present invention provides a system and method for verifying information, such as user identity information and location, as well as authorization information, such as approval for charges for goods or services, which are usable for such functions as providing remote purchasing by and billing of users. In general, two elements of information are required, in accordance with embodiments of the present invention, in order to establish verification and authorization: 1) establishment of identity of the user; and 2) establishment of location information for the user that is linkable to that user.

As will be clear to those skilled in the art, establishment of identity and location information in accordance with the present invention may be obtained via a variety of devices and processes. For example, in one embodiment of the present invention, verification and authorization for a user is provided via use of a “soft wire” contact with the user (e.g., computer network based communication) and a “hard wire” contact with the user (e.g., wired communication via a telephone network). The combination of use of the soft wire contact and the hard wire contact provides a mechanism for confidently verifying the user's identity and authorization for such events as account charges for goods and services ordered. In addition, with particular activities performed in accordance with the method of use of such contacts, in accordance with embodiments of the present invention, certain requirements under Federal law relating to such verification and charging are met, including, but not limited to, requirements under the Federal Trade Commission's (FTC's) Trade Regulation Rule Pursuant to the Telephone Disclosure and Dispute Resolution Act of 1992 (“900 Number Rule”), 16 C.F.R. 308, et seq.; the FTC's Children's Online Privacy Protection Rule (“COPPA Rule”); Section 5 of the FTC Act, 15 U.S.C.§ 45; the Helms Amendment, 47 U.S.C. § 223(e)(5)(B); and the Child Online Protection Act (“COPA”), 47 U.S.C. § 231(c).

Other systems and methods of establishing identity and location information for the user may also be used in accordance with embodiments of the present invention. For example, identity may be established via use of voice print capture or other biometic information, or use of these identifiers in conjunction with the above described methods; use of national identification cards or other specialized cards for positively identifying an individual; and use of a smart card containing a digital signature or for which a digital signature can be provided. Location information can likewise be established via any of a number of methods and systems. For example, location information may be established via use of geographical positioning system (GPS) devices and systems, cellular telephone locating, and other systems and methods for geographically locating a user's position that are known in the art.

In addition, mobile communication or other devices, such as cellular telephones, pagers, personal digital assistants (PDAs), and other hand-held and mobile devices, as well as non-mobile devices, such as telephones, terminals on networks, or other network devices, such as digitally communicating devices (e.g., terminals coupled to cable, fiber-optic, or satellite communications systems), may be used to establish communication with the user and, in some cases, to locate the user. Any of the above mobile user input devices may be used to provide identification information specific to the user, and additional devices may be used or used in conjunction with the above devices, such as biometric input devices and electronic signature input devices coupled to the mobile communications or other devices. In addition to location being established by, for example, location of the device used by the user, verification or additional location information may be obtained, in accordance with embodiments of the present invention, via other systems and devices, such as via user input of information.

In one embodiment of the present invention, soft wire and hard wire contacts are used to verify the identity, including, in some embodiments, age, and location of the user, in order that, for example, products and services ordered by the user may be provided to the user and billed to a correct account (e.g., the user's home telephone number based account), rather than requiring, for example, use of a user's charge or credit card.

For example, in an embodiment of the present invention, the identity verification process includes the following activities via the host server. The user transmits application information, including personal identification information and government database verifiable information to the host server. The host server verifies the provided information by accessing one or more third-party databases, and, upon receipt of such database verification, produces and transmits a digital certificate to the user, and establishes contact with the user via a hard connection (e.g., wired telephone network). The user activates the digital certificate by accessing the computer network and the telephone network. Following verification and approval, the user may access the Web-based content using the digital certificate. The user's home telephone number account will be billed for the cost of accessing the Web-based content. From a Web site point of view, for example, the Web site is simply modified to include the option to pay via the method of the present invention, and user is seamlessly directed to the host server for payment process initiation.

Once identity and location information are established, the user is then able to transfer authorization among devices and locations, such as to a mobile device, via, for example, transfer of the digital certificate or other authorization to that device.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 presents an overview of system components, in accordance with a first example embodiment of the present invention;

FIG. 2 provides an overview of system components, in accordance with a second example embodiment of the present invention;

FIG. 3 shows an overview of system components, in accordance with a third example embodiment of the present invention;

FIG. 4 is a flowchart illustrating an overview of a general purchase request requiring verification of identity and location information for a user, in accordance with an embodiment of the present invention;

FIG. 5 is a flowchart of an example identity and location verification method, in accordance with one embodiment of the present invention; and

FIGS. 6 and 7 contain flowcharts that sets forth the details of an example process for providing user information access, in accordance with an embodiment of the present invention.

### DETAILED DESCRIPTION

The present invention overcomes the identified problems of the prior art, as well as others, by providing a method and system for establishing or verifying a user's identity and location. By providing such a method and system, the present invention is able to assure such information as a user's age and identity, as well as, for example, to establish a reliable vehicle for billing the user via determination of the user's location. One embodiment of the present invention includes use of a Digital Certificate to attest to identity of the user, and billing and collection of goods and services via a 900 call process.

More particularly, in one exemplary embodiment, the present invention uses both soft and hard connection to the user (e.g., Internet based and wired telephone based connection, respectively) to verify the user's identity and the location from which the user is attempting to obtain goods or services. As part of the process of authentication and approval for billing, a digital certification is obtained via the soft and hard connections. The use of both soft and hard connection for obtaining this information greatly increases the likely veracity of the verification and approval obtained. The approach of the present invention, in accordance with this example embodiment, also meets the compliance criteria set forth under COPPA, CODA, and the HELMS Amendment, among other legal requirements.

A specific example of providing user information access, in accordance with an embodiment of the present invention, will now be described in detail. This example is intended to be merely representative of one application of the present invention to example facts, and therefore not to be limiting to the specific information and functions described.

In this example, an Internet user who does not have a credit or charge card, or who elects not to use such a card, selects an option to establish billing in accordance with the present invention for information access services at a Web site. To provide these services, in accordance with this example use of the present invention, the Web site requests the user to provide identification information, including, for example, the user's name, address, home telephone number, electronic mail (e-mail) address, and date of birth. In addition, the user is required to provide at least one form of government issued and verifiable data, such as a driver's license number, a voter registration number, or a social security number.

Following provision of this information, initial verifications may be conducted based on the input information alone, such as a preliminarily verification that the user is of sufficient age to obtain the services, based on the birth date information provided by the user. For example, if it is determined that the user is under age for services requested that require the user to be 18 or over, the session may be terminated, and a blocking event initiated, such as prevention of access to the site for the user for a predetermined time. For example, if the user is using a personal computer (PC) to access the Web site, a “session cookie” lasting at least 24 hours may be placed on the user's PC to prevent the user from accessing the Web site and entering a new birth date.

Following any initial verification, identity is established. For example, in the exemplary embodiment described above, a query is made of third party databases to confirm that the name and address information provided by the user matches the name and address information associated with the selected government issued information obtained from the queried database. For example, a third party database of driver's license information that includes the driver's name and home address may be used to obtain the name and driver's license associated with the driver's license number provided by the user, and the retrieved information is compared to the name and home address information provided by the user.

Consequences or further actions may occur depending on the results of this comparison. For example, if an exact match of information is not obtained, the user may be prompted to provide a second form of government issued and verifiable information, and a second comparison may then be made using the second form of information. If this second comparison also fails to completely match, the user may be prompted to provide valid credit or charge card information in order to proceed.

Upon, for example, one of the two forms of information producing an exact match, the user's identity is confirmed, and a certification of the identity information issues. For example, a Digital Certificate may be issued to the user. The user is then provided with further procedural instructions and requests for information, including, for example, providing the user with a PIN and instructions to call a predetermined number, such as a 900 number, in order to obtain the Digital Certificate, to finalize billing agrements, and, for example, to obtain additional information for accessing the Web site information sought.

The location of the user is next established. For example, using the above provided information, the user calls the predetermined number and enters the PIN provided. An ANI process is initiated for the telephone number from which the user places the call similar to caller ID. A verification is made that a Digital Certificate has been created having associated user information that corresponds to the ANI information obtained (e.g., the user name and address information used to create the Digital Certificate matches the ANI name and address information obtained). Failure can produce consequences or result in additional requirements. For example, if the Digital Certificate and ANI information do not match, the call may be terminated and no charges generated for the telephone number for which the ANI was performed.

If location is established, such as occurs, when for example, the Digital Certificate and ANI information match, the user is verified. For example, the Digital Certificate may be activated and issued to the user, such as via an e-mail message, and the user instructed to access the Web site. Following a match occurring for the Digital Certificate and the ANI information, in this example, and the user's acceptance of the billing terms. For example, a 900 Call Record may be created and a bill generated to the telephone number from which the ANI was conducted for any services obtained by the user. To complete this process, for example, upon accessing the Web site, the user may enter a code or other information associated with the issued Digital Certificate, in order to be able to obtain goods or services.

In an embodiment of the present invention, in accordance with the above example, a host (e.g., a business providing billing services) is able to provide verified identification and confirmation for billing to users (e.g., consumers) for purchases of products (e.g., books, clothes, and other goods) and services (e.g., entertainment service, business services) over a network, such as the Internet. For example, a Web site is able to offer the user the ability to pay for Web-based content billed via a host telephone number, such as billing to a 900 number.

References will now be made in detail to embodiments of the present invention, examples of which are illustrated in the accompanying drawings.

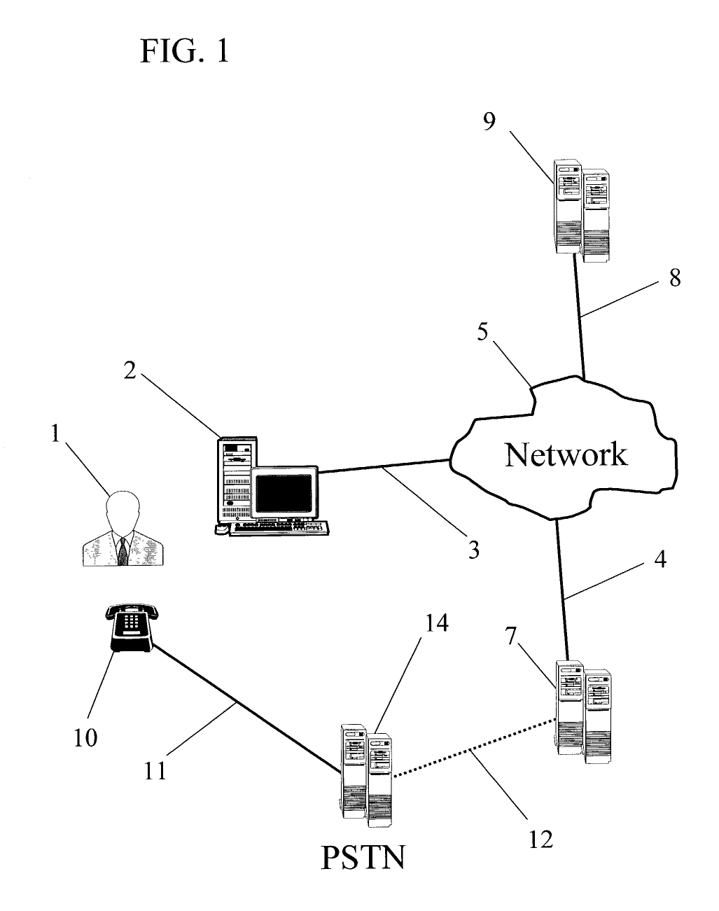

FIG. 1 presents an overview of system components, in accordance with a first example embodiment of the present invention. As shown in FIG. 1, in this embodiment, a user 1 (e.g., an Internet user attempting to pay for purchases) transmits information, such as personal identification information, via a user terminal 2. The user terminal 2 includes or consists of, for example, a PC, a minicomputer, a microcomputer, a mainframe computer, a telephone device, a hand-held wireless electronic device, or other device with a processor and communication capability.

Information input to the user terminal 2 is transmitted via couplings 3, 4 and a network 5 (e.g., the Internet) to a host server 7. The host server 7 comprises, for example, a PC, a minicomputer, a microcomputer, a mainframe computer, or other device having a processor and repository for data or coupling 8 (e.g., via network 5) to a repository for data 9. The couplings 3, 4, 8 include, for example, wired, wireless, or fiberoptic links.

The host server 7 verifies the user information by, for example, comparing the information received from the user terminal 2 to information received from the accessed repository 9, such as government database information (e.g., social security information, driver's license information, or voter registration information). If the information is verified, the host server 7 generates a certification for the user, such as a Digital Certificate, and transmits to the user terminal 2 a verification request, including, for example, a host telephone number (e.g., a 900 number) and a PIN number for the user 1.

The user 1 contacts the host server 7 using a communication device 10, such as a telephone, via couplings 11, 12 and a second network 14, such as a telephone network, and inputs verification information, such as the PIN number for the user 1. The host server 7 obtains location information for the location of the communication device 10, such as via an ANI process. The host server 7 then compares received ANI information, such as the address for the location of the communication device 10, to the verified information received from the user terminal 2.

Upon verification, the certification is transmitted from the host server 7 to the user terminal 2, along with, for example, instructions as to how the user 1 is to proceed to obtain goods or services and to be billed. The user 1 is then billed for such goods and services, for example, via billing of the account corresponding to the location of the communication devices 10.

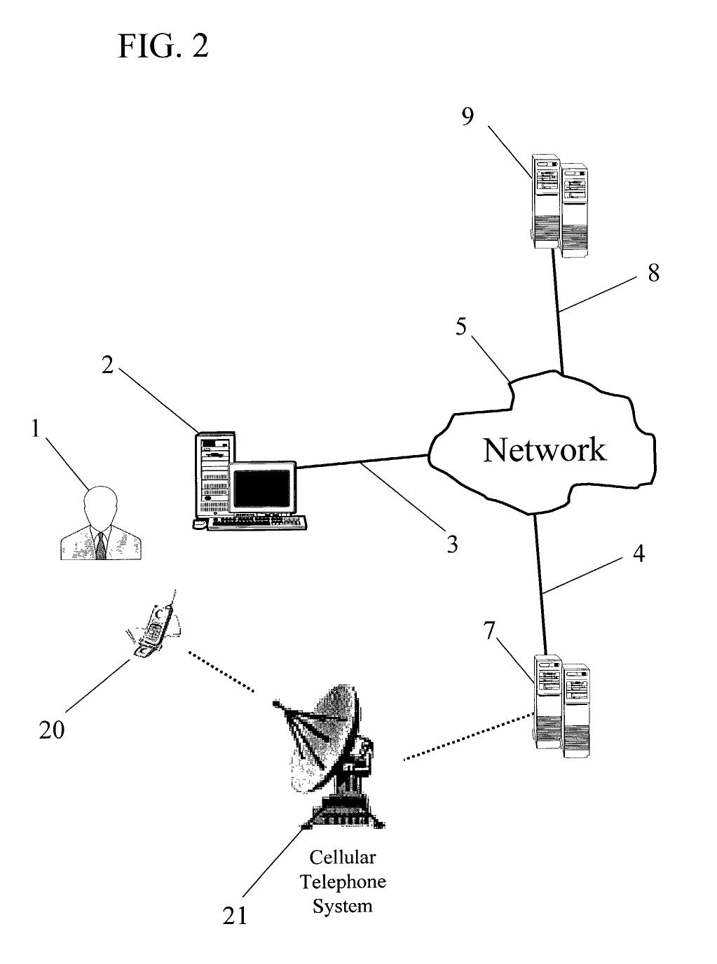

FIG. 2 provides an overview of system components, in accordance with a second example embodiment of the present invention. The components and functions of the user terminal 2, couplings, 3, 4, 8, host server 7, repository 9, and network 5 of the system of FIG. 2 are largely similar to those for the components and functions of FIG. 1. In contrast with FIG. 1, however, in the example of FIG. 2, the location information for the user 1 is obtained via information for a mobile communication device 20, such as a cellular telephone. For example, in the example embodiment shown in FIG. 2, location information for the mobile communication device 20 may be obtained by a cellular telephone system 21 by use of cellular positioning system location information. The obtained location information is then obtained by the host server 7 for conversion, for example, to location information for comparison to location information contained in the information received from the user terminal 2.

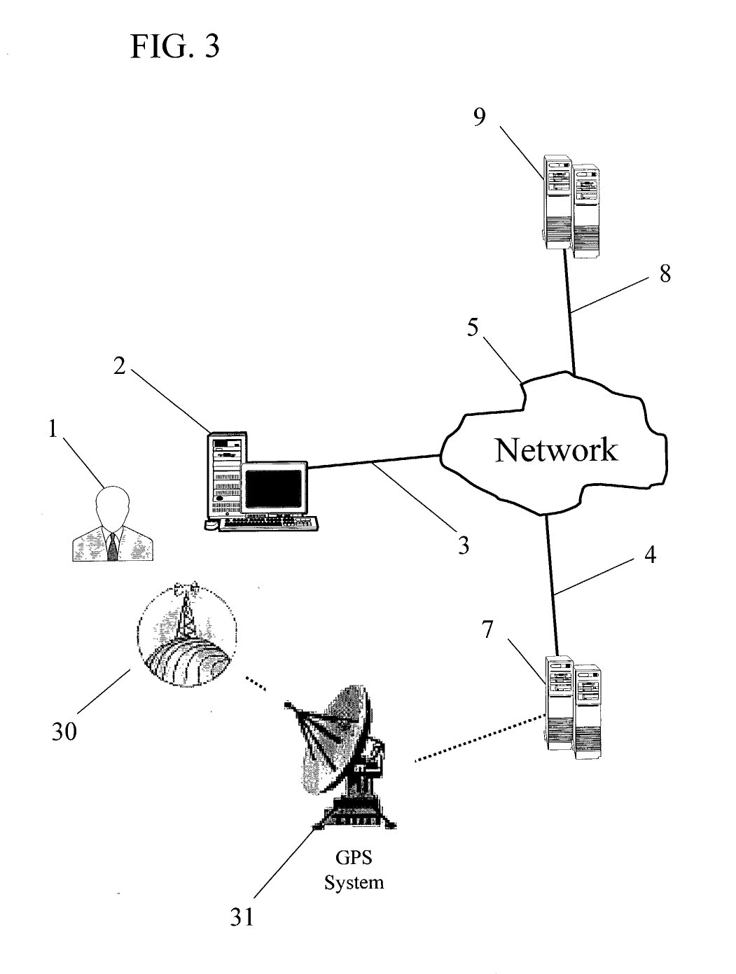

FIG. 3 shows an overview of system components, in accordance with a third example embodiment of the present invention. FIG. 3 contains similar components and functionality to those shown in FIG. 2, except that in FIG. 3, location information for the user 1 is provided via a GPS transmitter 30, and location information is obtained by a GPS system 31 for use by the host server 7.

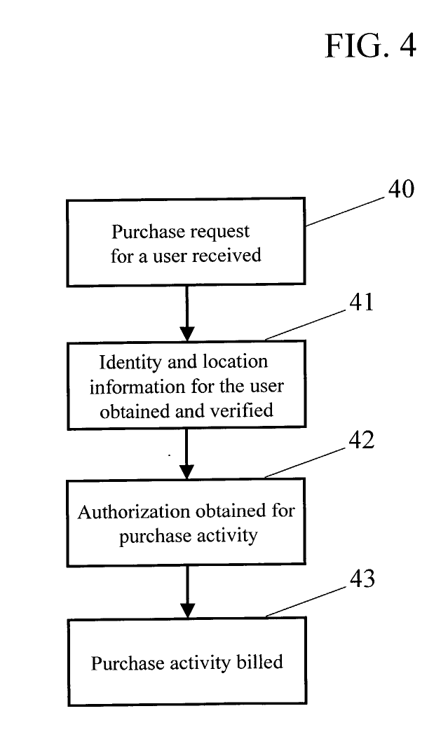

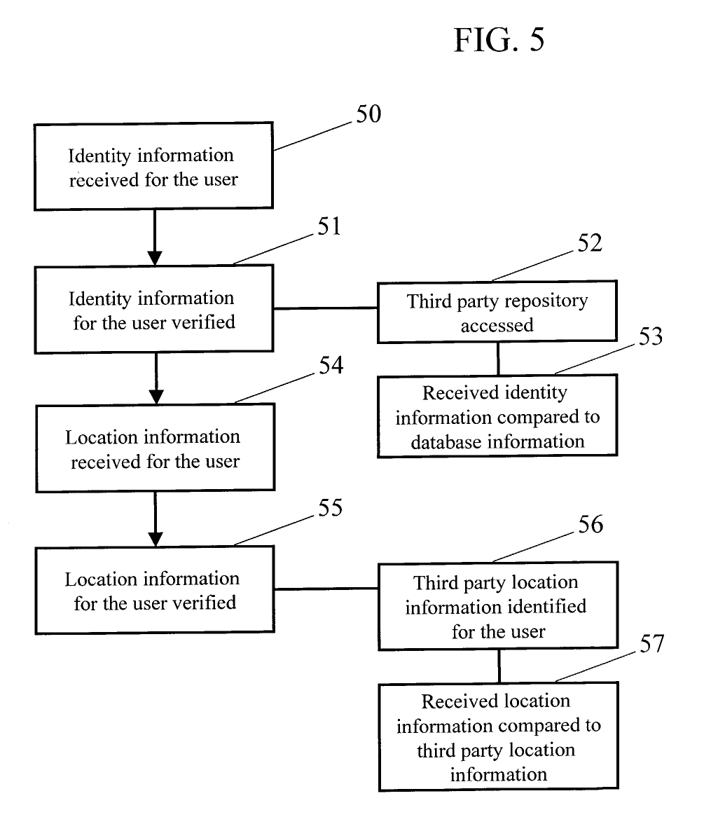

FIG. 4 is a flowchart illustrating an overview of a general purchase request requiring verification of identity and location information for a user, in accordance with an embodiment of the present invention. As shown in FIG. 4, a purchase request is received for a user 40, such as a request to make a purchase for goods or services on the Internet using 900 number or other non-credit card or non-charge card billing. As is discussed further below, for example, in conjunction with FIGS. 5, 6, and 7, identity and location information for the user is then obtained and verified 41. Following verification of the identity and location information for the user, authorization is obtained for purchase activity 42, such as by providing a user with a Digital Certificate and authorization information for purchase activities. Any purchase activity is then appropriately billed 43, such as by billing the home telephone number for the user, which was obtained and for which billing was authorized during the obtaining and verification of the identity and location information 41 and during the obtaining of authorization for purchase activity 42.

FIG. 5 is a flowchart of a representative example of an identity and location verification method, in accordance with one embodiment of the present invention. As shown in the example method of FIG. 5, identity information is received for the user 50, such as via transmission by a user on a user terminal to a host server, as further described above with regard to FIG. 1. The identity information for the user is then verified 51. In the example shown in FIG. 5, the identity verification includes accessing a third party repository 52, such as a database of government information (e.g., driver's license information, voter registration information, or social security information), and comparing the received identity information to information in the repository for the user 53. Other or additional methods and devices may also be used to confirm identity, including, for example, collection, use, and verification of biometric information.

As further shown in the example method of FIG. 5, following verification of the identity information for the user, location information is received for the user 54, such as via information obtained from an ANI process for a telephone communication by the user, as discussed further above with regard to FIG. 1, or via information obtained, for example, by cellular telephone positioning or GPS positioning for the user, as discussed with regard to FIGS. 2 and 3, above. In an embodiment of the present invention, the location information for the user (e.g., address) is then verified 55. In the example embodiment shown in FIG. 5, for verification, location information for the user is identified from the third party repository 56, consistent, for example, with identity information received from the user 50. This identified location information is then compared to the received location information 57.

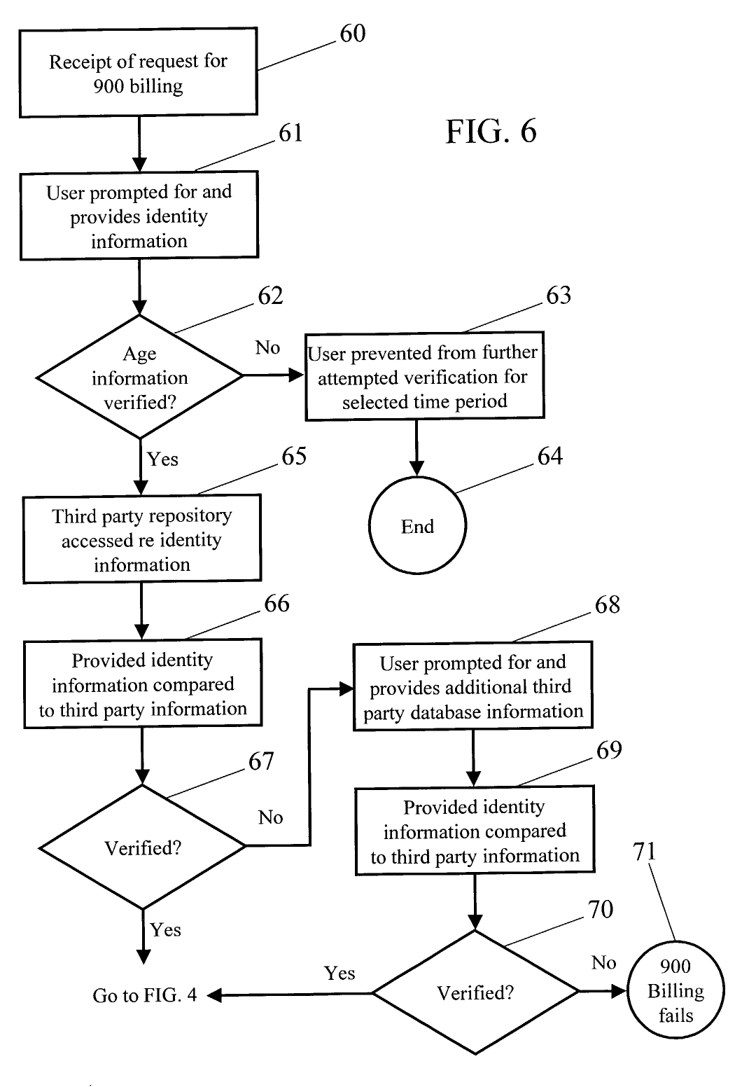

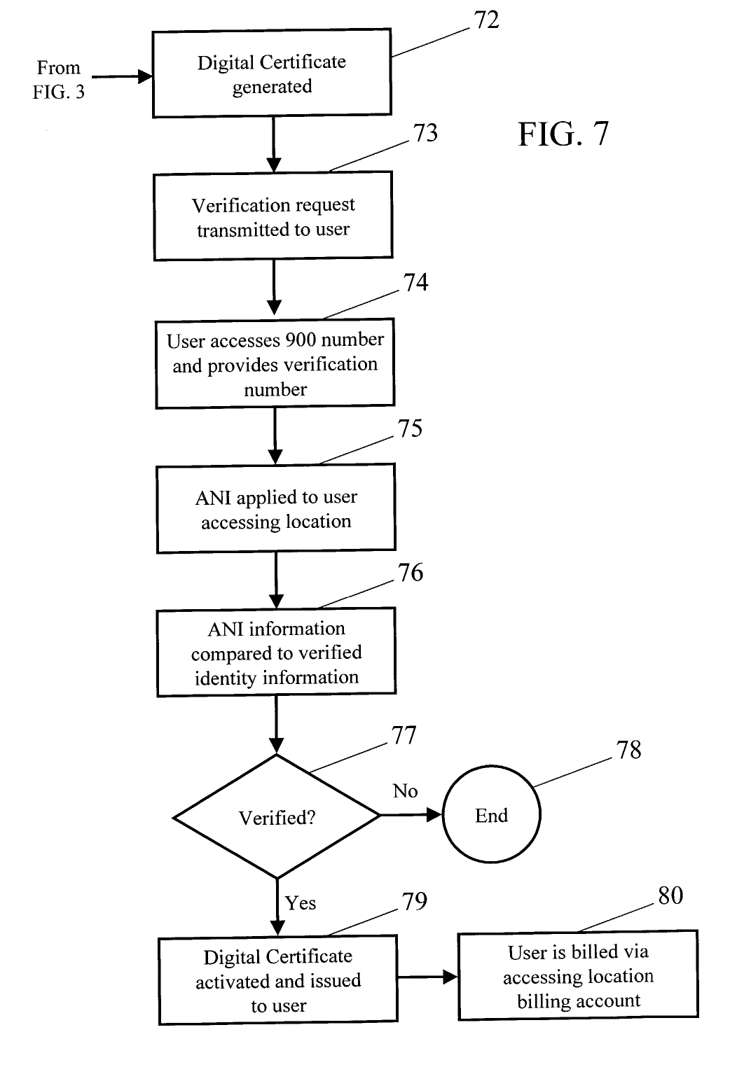

FIGS. 6 and 7 contain flowcharts that set forth the details of an example process for providing user information access, in accordance with an embodiment of the present invention. In this example, a user who does not have a credit or charge card, or who elects not to use such a card, selects to establish billing in accordance with the present invention. To obtain this billing, in accordance with this example use of the present invention, the user first provides a request for such billing 60, such as billing via a 900 number. The user is then prompted for and provides identity information 61, such as the user's name, address, home telephone number, e-mail address, and date of birth. In addition, the user is required to provide at least one form of government issued and verifiable data, such as a driver's license number, a voter registration number, or a social security number.

Following provision of this information, a first preliminarily verification is made that the user is of sufficient age to obtain the services 62, based, for example, on the birth date information provided by the user. If it is determined that the user is under age for the services, a blocking event optionally occurs, such as initiating an action to prevent access to the site for the user for a predetermined time 63, and the session is terminated 64.

If the initial determination is that the user is of sufficient age to access the site 62, a query is made of third party databases 65, and retrieved information is compared to the name and address information provided by the user 66. If an exact match of information is not obtained by this comparison 67, the user is prompted to provide a second form of government issued and verifiable information 68, and a second comparison is made using the second form of information 69. If this second comparison also fails to completely match 70, the billing method fails 71, and, for example, the user may be prompted to provide valid credit or charge card information in order to proceed with billing.

If one of the two forms of information does produce an exact match 67, 70, the user's identity is confirmed, and a certification of the identity information issues 72, as shown in FIG. 7, such as a Digital Certificate. The user is provided with a verification request 73, such as by e-mail, which includes, for example, transmission of a verification number, such as a PIN for the user, and instructions to call a predetermined number, such as a 900 number, to obtain the Digital Certificate, to finalize billing arrangement, and to obtain additional information for accessing the Web site information sought.

It is noted that obtaining consumer identity via e-mail and government issued identification that verifies that the user is an adult (i.e., dual means of authentication), along with issuance of a Digital Certificate containing verification that the user is an adult, establishes a compliance step with COPPA requirements.

The user then calls the predetermined number and enters the PIN provided 74. In this example embodiment, to establish location, an ANI process is initiated for the telephone number from which the user places the call 75. A comparison is made between the associated user information for the certification and the corresponding ANI information obtained (e.g., the user name and address information used to create the Digital Certificate matches the ANI name and address information obtained) 76. If the Digital Certificate and ANI information do not match 77, the call is terminated 78 and no charges are generated for the telephone number for which the ANI was performed.

If the Digital Certificate and ANI information do match 77, the Digital Certificate is activated and is issued to the user 79 once they call the 900 number and agree to the billing terms, such as via an e-mail message. The user is also instructed to access the Web site and to send a reply e-mail. Following a match occurring for the Digital Certificate and the ANI information, a 900 Call Record is created, and a bill is generated to the telephone number for which the ANI was conducted 80, for example, for the services obtained or to be obtained by the user. To complete this process, for example, upon accessing the Web site, the user enters code or other information associated with the issued Digital Certificate, sends a reply e-mail message, and is able to obtain the services.

It is noted that obtaining consumer sending the reply e-mail above establishes a second compliance step with COPPA requirements.

Once identity and location information are established, the user is then able to transfer authorization among devices and locations, such as to a mobile device, via, for example, transfer of the digital certificate or other authorization to that device. For example, a user may wish to determine ordering information for purchases, or browse purchased and downloaded network information, via the user's hand-held device (e.g., PDA) while the hand-held device is disconnected from any network. The user simply transfers the authorization from, for example, the user's home PC, to the hand-held device, and then authorized activities (e.g., downloading content) can then be performed on the hand-held device using synchronization.

Example embodiments of the present invention have been described in accordance with the above advantages. It will be appreciated that these examples are merely illustrative of the invention. Many variations and modifications will be apparent to those skilled in the art.

What is claimed is:

1. A method for verifying identification and location information for a user, comprising:
receiving identity information for the user;
verifying the identity information for the user via a third party identification source;
receiving location information for the user; and
verifying the location information for the user via a third party user location source.

2. The method of claim 1, further comprising:
preliminarily verifying the received identity information for the user.

3. The method of claim 2, wherein preliminarily verifying the received identity information for the user includes verifying age information for the use based on the received identity information.

4. The method of claim 2, further comprising:
upon failure to preliminarily verify the received identity information for the user, preventing additional verification for the user.

5. The method of claim 4, wherein preventing additional verification for the user includes placing a cookie on a terminal.

6. The method of claim 5, wherein the terminal is selected from a group consisting of a personal computer, a minicomputer, a main frame computer, a telephone device, and a hand-held device.

7. The method of claim 1, wherein the identity information is received for the user via a soft wire communication.

8. The method of claim 7, wherein the identity information is received for the user via a network.

9. The method of claim 8, wherein the network includes the Internet.

10. The method of claim 1, wherein verifying the identity information for the user via a third party identification source includes:
comparing the received identity information for the user to identity information for the user located in third party repositories.

11. The method of claim 10, wherein the third party repositories include databases of government information.

12. The method of claim 10, wherein the third party repositories include information selected from a group consisting of driver's license information, social security information, and voter registration information.

13. The method of claim 1, wherein the identity information for the user is selected from a group consisting of the user's name, the user's address, the user's telephone number, the user's e-mail address, and the user's date of birth.

14. The method of claim 10, wherein verifying the identity information for the user further includes:
upon the received identity information for the user and the identity information for the user located in third party repositories failing to match, obtaining additional third party repository match information for the user; and
comparing the obtained additional third party repository match information to additional third party repository information in the third party repository.

15. The method of claim 1, further comprising:
upon verification of the identity information for the user via the third party identification source, issuing a digital certificate for the user.

16. The method of claim 1, further comprising:
upon verification of the identity information for the user via the third party identification source, providing a verification number for the user.

17. The method of claim 16, wherein the verification number is a personal identification number.

18. The method of claim 1, wherein receiving location information for the user includes:
establishing a hard wire connection with the user.

19. The method of claim 1, wherein receiving location information for the user includes:
establishing communication with the user via a telephone network; and
receiving location information for the user via the telephone network.

20. The method of claim 19, where the received location information includes automatic number identification information.

21. The method of claim 1, wherein receiving location information for the user includes:
obtaining geographical positioning system location information for the user.

22. The method of claim 1, wherein receiving location information for the user includes:
obtaining cellular telephone positioning location information for the user.

23. The method of claim 1, wherein verifying the location information for the user via a third party location source includes:
comparing the received location information for the user to location information associated with the verified identity information for the user.

24. The method of claim 23, wherein the received location information includes address information obtained via automatic number identification.

25. The method of claim 23, wherein the information associated with the verified identity information for the user includes address information.

26. A method for billing a user for remotely requested purchases, comprising:
receiving identity information for the user;
verifying the identity information for the user via a third party identification source;
receiving location information for the user;
verifying the location information for the user via a third party user location source; and
receiving confirmation information for billing the user.

27. The method of claim 26, wherein receiving the confirmation information includes:
receiving a verification number.

28. The method of claim 26, wherein the verification number comprises a personal identification number.

29. The method of claim 26, wherein the confirmation information for billing the user includes a request for purchase.

30. The method of claim 29, wherein the request for purchase includes a request for information via a site on a network.

31. The method of claim 30, wherein the network is the Internet.

32. The method of claim 26, further comprising:
issuing a digital certificate; and
transmitting the digital certificate to the user.

33. The method of claim 32, wherein verifying the location information for the user via a third party location source includes:
comparing the received location information for the user to location information associated with the verified identity information for the user.

34. The method of claim 33, wherein the received location information includes address information obtained via automatic number identification.

35. The method of claim 33, wherein the information associated with the verified identity information for the user includes address information.

36. The method of claim 34, wherein the digital certificate is associated with an account for a telephone number associated with automatic number identification.

37. The method of claim 32, wherein the digital certificate is associated with a first device, the method further comprising:
transferring the association of the digital certificate from the first device to a second device.

38. The method of claim 37, wherein the second device is a mobile device.

39. A system for verifying information, comprising:
a first network to which a user terminal is coupleable;
a host server coupled to the first network;
at least one repository accessible by the host server; and
a second network to which a user communication device is coupleable;
wherein identity information for a user is received by the host server;
wherein the identity information for the user is verified via accessing the at least one repository;
wherein location information for the user is received by the host server; and
wherein the location information for the user is verified via accessing the at least one repository.

40. The system of claim 39, wherein the first network is the Internet.

41. The system of claim 39, wherein the user terminal is selected from a group consisting of a personal computer, a minicomputer, a microcomputer, a main frame computer, a hand held device, and a telephone.

42. The system of claim 39, wherein the host server is selected from a group consisting of a personal computer, a minicomputer, a microcomputer, and a main frame computer.

43. The system of claim 39, wherein the repository comprises a database of government issued information.

44. The system of claim 39, wherein the repository includes information selected from a group consisting of driver's license information, votor registration information, and social security information.

45. The system of claim 39, wherein the second network comprises telephone network.

46. The system of claim 39, further comprising:
a geographical positioning system;
wherein the location information for the user is determined using geographical information received via the geographical positioning system.

47. A system for verifying information, comprising:
means for receiving identity information for the user;
means for verifying the identity information for the user via a third party identification source;
means for receiving location information for the user; and
means for verifying the location information for the user via a third party user location source.
